(19) United States
(12) Patent Application Publication
(10) Pub. No.: US 2026/0042910 A1
(43) Pub. Date: Feb. 12, 2026

(54) RESIN COMPOSITION

(71) Applicant: Resonac Corporation, Tokyo (JP)

(72) Inventors: Shigeru KURIMOTO, Tokyo (JP); Kazuhiko MORI, Tokyo (JP); Rei SATAKE, Tokyo (JP)

(21) Appl. No.: 19/102,119

(22) PCT Filed: Aug. 14, 2023
(86) PCT No.: PCT/JP2023/029443

§ 371 Date: Feb. 7, 2025

(30) Foreign Application Priority Data
Aug. 16, 2022 (JP) 2022-129611

(51) Int. Cl. C08L 53/02; C08F 8/32; C08F 297/04; C08G 61/02; C08K 3/36; C08K 5/3445; C08K 9/06; C08L 63/10; C08L 65/00

(52) U.S. Cl. CPC C08L 53/025; C08L 63/10; C08L 65/00; C08F 8/32; C08F 297/04; C08G 61/02; C08G 2261/149; C08K 3/36; C08K 5/3445; C08K 9/06

(57) ABSTRACT

The present disclosure relates to a resin composition containing a modified styrene-based elastomer having an N-substituted succinimide group in a side chain and a thermosetting resin.

### TECHNICAL FIELD

The present disclosure relates to a resin composition.

### BACKGROUND ART

In mobile communication devices represented by mobile phones, their base station equipment, network infrastructure devices such as servers and routers, and electronic devices such as large-sized computers, the speed and capacity of signals used are increasing year by year. Accordingly, printed wiring boards mounted on these electronic devices are required to be capable of operating at higher frequencies, and there is a demand for substrate materials having a low relative dielectric constant and a low dielectric tangent that enable a decrease in transmission loss. In recent years, as applications that handle such high-frequency signals, in addition to the electronic devices mentioned above, new systems that handle high-frequency wireless signals have been put into practical use and are planned for practical use in the ITS field (motor vehicles and traffic systems) and the field of indoor short-range communications, and it is expected that in the future, there will be an increased demand for substrate materials having a low transmission loss for printed wiring boards mounted on these devices.

As resin materials for printed wiring boards, it is known to use styrene-based elastomers, maleimide compounds having an N-substituted maleimide group, and the like (see, for example, Patent Literatures 1 and 2).

### CITATION LIST

### Patent Literature

Patent Literature 1: WO 2014/148155 A1
Patent Literature 2: WO 2016/175326 A1

### SUMMARY OF INVENTION

### Technical Problem

Styrene-based elastomers do not have a polar group, and thus tend to be compatible with other components such as a thermosetting resin. Meanwhile, modified styrene-based elastomers having an acid anhydride group, which are modified with maleic anhydride or the like, are excellent in compatibility with other components, but tend to be poor in stability since the acid anhydride undergoes ring opening due to moisture in the air, and the like. Accordingly, an object of the present disclosure is to provide a resin composition containing a modified styrene-based elastomer that is excellent in stability.

### Solution to Problem

In order to achieve the object, an aspect of the present disclosure relates to the following resin composition.
[1] A resin composition containing a modified styrene-based elastomer having an N-substituted succinimide group in a side chain; and a thermosetting resin.
[2] The resin composition according to [1], in which the N-substituted succinimide group has a structure represented by the following Formula (1):

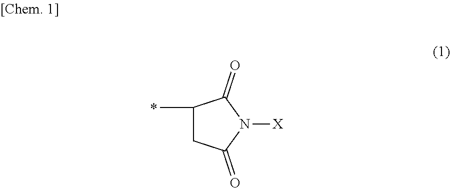

wherein in Formula (1), X represents a monovalent organic group, and * represents a bonding portion.
[3] The resin composition according to [2], in which the X is a monovalent organic group having at least one selected from the group consisting of an isocyanate group, a hydroxyl group, a carboxyl group, a silanol group, a thiol group, a sulfo group, a phosphoric acid group, a cyclic ether group, a carbonate group, a nitrile group, a (meth)acryloyl group, a vinyl group, a maleimide group, an imidazole group, an oxazoline group, a benzotriazole group, and a benzoxazine group.
[4] The resin composition according to [2], in which the N-substituted succinimide group has a structure represented by the following Formula (2) or the following Formula (3):

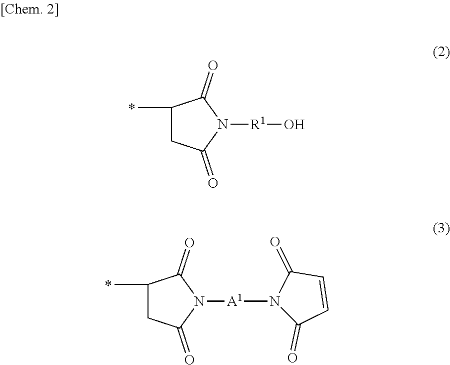

wherein in Formula (2), R¹ represents a residue of an amine compound having a hydroxyl group, and * represents a bonding portion, and in Formula (3), A¹ represents a residue of a diamine compound, and * represents a bonding portion.
[5] The resin composition according to any one of [1] to [4], in which the thermosetting resin includes at least one selected from the group consisting of an epoxy resin, a cyanate ester resin, an acrylic resin, a silicone resin, a phenol resin, a maleimide resin, a thermosetting polyimide resin, a polyurethane resin, a melamine resin, and a urea resin.
[6] The resin composition according to any one of [1] to [5], in which a content of the modified styrene-based elastomer is 1% to 50% by mass based on a total amount of solids in the resin composition.

### Advantageous Effects of Invention

According to the present disclosure, it is possible to provide a resin composition containing a modified styrene-based elastomer that is excellent in stability.

### DESCRIPTION OF EMBODIMENTS

Hereinafter, suitable embodiments of the present disclosure will be described in detail. However, the present disclosure is not limited to the following embodiments. In the present specification, the term “step” includes not only an independent step but also a step that cannot be clearly distinguished from other steps as long as the intended action of the step is achieved. In the present specification, the term “layer” encompasses a structure having a shape formed on a part as well as a structure having a shape formed on the entire surface when observed in a plan view.

In the present specification, a numerical range indicated using “to” indicates a range including the numerical values before and after “to” as the minimum and maximum values, respectively. In numerical ranges described in stages in the present specification, the upper limit or lower limit in a numerical range in a certain stage may be replaced with the upper limit or lower limit in a numerical range in another stage. In a numerical range described in the present specification, the upper limit or lower limit in the numerical range may be replaced with values presented in Examples. In the present specification, in a case of referring to the amount of each component in a composition, the amount refers to the total amount of a plurality of substances present in the composition in a case where the plurality of substances corresponding to each component are present in the composition, unless otherwise specified. “A or B” means that it is only required to contain either A or B and both A and B may be contained. “Solids” refer to the non-volatile components in a resin composition excluding volatile substances (water, solvent and the like). In other words, “solids” refer to components other than the solvent that remain without volatilizing during drying of a resin composition described later, and also include components that are liquid, syrup-like, or waxy at room temperature (25° C.).

### [Resin Composition]

The resin composition according to the present embodiment contains a modified styrene-based elastomer having an N-substituted succinimide group in the side chain (hereinafter also referred to as “component (A)”) and a thermosetting resin (hereinafter also referred to as “component (B)”).

### (Modified Styrene-Based Elastomer)

The N-substituted succinimide group is less likely to undergo hydrolysis due to moisture in the air and the like and is excellent in compatibility with the thermosetting resin, which is the component (B), and therefore, the stability of the resin composition can be improved as a modified styrene-based elastomer having an N-substituted succinimide group is used as the component (A).

The component (A) can be produced by reacting a compound having an amino group with the acid anhydride group of a styrene-based elastomer modified with maleic anhydride. The styrene-based elastomer may be a copolymer having a structural unit derived from a styrene-based compound and a structural unit derived from a conjugated diene compound.

Examples of the styrene-based compound include styrene, α-methylstyrene, p-methylstyrene, and p-tert-butylstyrene. Among these, styrene, α-methylstyrene, and 4-methylstyrene are preferred and styrene is more preferred from the viewpoints of availability and productivity.

Examples of the conjugated diene compound include 1,3-butadiene, 2-methyl-1,3-butadiene (isoprene), 1,3-pentadiene (piperylene), 1-phenyl-1,3-butadiene, 2,3-dimethyl-1,3-butadiene, 2-methyl-1,3-pentadiene, 3,4-dimethyl-1,3-hexadiene, and 4,5-diethyl-1,3-octadiene. Among these, 1,3-butadiene and isoprene are preferred from the viewpoints of availability and productivity.

The styrene-based elastomer may be a hydrogenated styrene-based elastomer in which at least a part of the structural unit derived from a conjugated diene compound is hydrogenated. Examples of the hydrogenated styrene-based elastomer include a hydrogenated styrene-butadiene-styrene block copolymer (SEBS) and a hydrogenated product of styrene-isoprene-styrene block copolymer. Examples of commercially available products of SEBS include TUFTEC (registered trademark) H series and M series manufactured by Asahi Kasei Corp., SEPTON (registered trademark) series manufactured by Kuraray Co., Ltd., and KRATON (registered trademark) G Polymer series manufactured by KRATON CORPORATION.

The styrene-based elastomer modified with maleic anhydride may be produced by reacting maleic anhydride with a styrene-based elastomer or a hydrogenated styrene-based elastomer, or a commercially available product may be used.

The styrene-based elastomer modified with maleic anhydride can be produced, for example, by adding a radical generator to a mixture in which a styrene-based elastomer and maleic anhydride are dissolved in a solvent in a nitrogen atmosphere and reacting the maleic anhydride with the styrene-based elastomer. The reaction temperature may be 20° C. to 150° C. After the reaction, it is preferable to remove unreacted maleic anhydride by extraction from the viewpoint of suppressing side reactions.

As the radical generator, for example, an organic peroxide, an azo compound, and the like can be used. Examples of the organic peroxide include dicumyl peroxide, benzoyl peroxide, 2-butanone peroxide, tert-butyl perbenzoate, di-tert-butyl peroxide, 2,5-dimethyl-2,5-di(t-butylperoxy)hexane, bis(tert-butylperoxyisopropyl)benzene, and tert-butyl hydroperoxide. Examples of the azo compound include 2,2′-azobis(2-methylpropanenitrile), 2,2′-azobis(2-methylbutanenitrile), and 1, l′-azobis(cyclohexanecarbonitrile).

Examples of the solvent include butyl cellosolve, ethylene glycol monomethyl ether, propylene glycol monomethyl ether, methyl ethyl ketone, methyl isobutyl ketone, cyclohexanone, toluene, xylene, mesitylene, methoxyethyl acetate, ethoxyethyl acetate, butoxyethyl acetate, and ethyl acetate. These may be used singly or in a mixture of two or more kinds thereof. Among these, toluene, xylene, and propylene glycol monomethyl ether are preferred from the viewpoint of solubility.

The compound having an amino group is not particularly limited as long as it has one or more amino groups. Examples of the compound having an amino group include an amine compound having a hydroxyl group, an amine compound having an isocyanate group, an amine compound having a carboxyl group, an amine compound having a silanol group, an amine compound having a thiol group, an amine compound having a sulfo group, an amine compound having a phosphoric acid group, an amine compound having a vinyl group, an amine compound having a (meth)acryloyl group, an amine compound having a nitrile group, an amine compound having a cyclic ether group, and a diamine compound having two amino groups.

The N-substituted succinimide group may be a group having a structure represented by the following Formula (1).

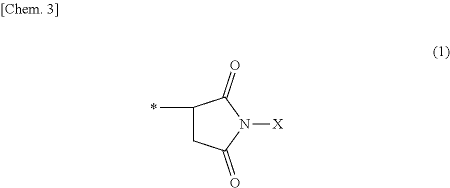

In Formula (1), X represents a monovalent organic group, and represents a bonding portion. Examples of X include a monovalent organic group having at least one selected from the group consisting of an isocyanate group, a hydroxyl group, a carboxyl group, a silanol group, a thiol group, a sulfo group, a phosphoric acid group, a cyclic ether group, a carbonate group, a nitrile group, a (meth)acryloyl group, a vinyl group, a maleimide group, an imidazole group, an oxazoline group, a benzotriazole group, and a benzoxazine group. From the viewpoints of reactivity, curability, heat resistance, and compatibility, X may be a monovalent organic group having an isocyanate group, a hydroxyl group, a carboxyl group, a maleimide group, or a benzoxazine group.

In a case where X is a monovalent organic group having a hydroxyl group, the N-substituted succinimide group may be a group having a structure represented by the following Formula (2). In Formula (2), R¹ represents a residue of an amine compound having a hydroxyl group, and * represents a bonding portion. A “residue” refers to the structure of the moiety remaining when a functional group involved in bonding is excluded from a raw material component.

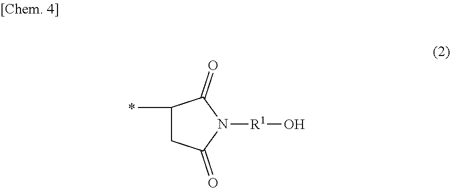

The modified styrene-based elastomer having a group having a structure represented by Formula (2) may be a reaction product of a styrene-based elastomer modified with maleic anhydride with an amine compound having a hydroxyl group.

Examples of the amine compound having a hydroxyl group include amines having an alcoholic hydroxyl group, such as hydroxyethylamine; and amines having a phenolic hydroxyl group, such as tyramine and dopamine.

In a case where X is a monovalent organic group having a maleimide group, the N-substituted succinimide group may be a group having a structure represented by the following Formula (3). In Formula (3), A¹ represents a residue of a diamine compound, and * represents a bonding portion.

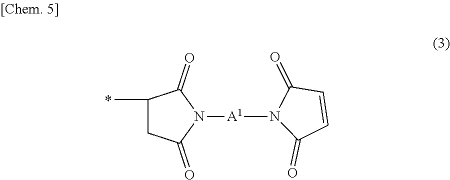

The modified styrene-based elastomer having a group having a structure represented by Formula (3) may be a reaction product of a styrene-based elastomer modified with maleic anhydride with a diamine compound and maleic anhydride.

Examples of the diamine compound include aliphatic diamines such as polyoxypropylenediamine; and aromatic diamines such as 4,4′-diaminodiphenylmethane, 4,4′-diaminodiphenyl ether, 4,4′-diaminodiphenyl sulfone, 3,3′-diaminodiphenyl sulfone, 4,4′-diaminodiphenyl ketone, 4,4′-diaminobiphenyl, 4,4′-diamino-3,3′-dimethyldiphenylmethane, 4,4′-diamino-3,3′-diethyldiphenylmethane, 2,2-bis(4-aminophenyl) propane, 2,2-bis(4-aminophenyl) hexafluoropropane, and 9,9-bis(4-aminophenyl) fluorene.

The content of the component (A) in the resin composition may be 1% to 50% by mass, 5% to 45% by mass, 10% to 40% by mass, 15% to 38% by mass, or 20% to 35% by mass based on the total amount of solids in the resin composition from the viewpoints of dielectric constant, elastic modulus, close contact properties, handling properties of the coating film, and compatibility.

### (Thermosetting Resin)

As the thermosetting resin that is the component (B), any resin that is cured by heat can be used without any particular limitation. Examples of the thermosetting resin include an epoxy resin, a cyanate ester resin, an acrylic resin, a silicone resin, a phenol resin, a maleimide resin, a thermosetting type polyimide resin, a polyurethane resin, a melamine resin, and a urea resin. These may be used singly or in combination of two or more kinds thereof.

Examples of the epoxy resin include a bisphenol A type epoxy resin, a bisphenol F type epoxy resin, a bisphenol S type epoxy resin, an alicyclic epoxy resin, an aliphatic chain epoxy resin, a phenol novolac type epoxy resin, a cresol novolac type epoxy resin, a bisphenol A novolac type epoxy resin, a phenol aralkyl type epoxy resin, naphthalene skeleton-containing type epoxy resins such as a naphthol novolac type epoxy resin and a naphthol aralkyl type epoxy resin, a bifunctional biphenyl type epoxy resin, a biphenylaralkyl type epoxy resin, a dicyclopentadiene type epoxy resin, and a dihydroanthracene type epoxy resin.

The content of the (B) component in the resin composition may be 10% to 60% by mass, 20% to 50% by mass, 25% to 48% by mass, or 30% to 45% by mass based on the total amount of solids in the resin composition.

### (Filler)

The resin composition of the present embodiment may further contain a filler as the component (C). By containing the filler as the component (C), it is possible to improve the low thermal expansion properties, high elastic modulus properties, heat resistance, flame retardancy and the like of the cured product formed from the resin composition.

Examples of the filler include silica, alumina, titanium oxide, mica, beryllia, barium titanate, potassium titanate, strontium titanate, calcium titanate, aluminum carbonate, magnesium hydroxide, aluminum hydroxide, aluminum silicate, calcium carbonate, calcium silicate, magnesium silicate, silicon nitride, boron nitride, calcined clay, talc, aluminum borate, and silicon carbide. These may be used singly or two or more kinds thereof may be used concurrently.

The shape and particle size of the filler are not particularly limited. The particle size of the filler may be, for example, 0.01 μm to 20 μm or 0.1 μm to 10 μm. Here, the particle size refers to the average particle size, and is the particle size at the point corresponding to 50% volume when a cumulative frequency distribution curve of particle sizes is determined assuming the total volume of the particles to be 100%. The average particle size can be measured using a particle size distribution measuring instrument by a laser diffraction scattering method.

For the purpose of improving the dispersibility of the filler and the close contact properties to an organic component, a coupling agent can be concurrently used if necessary. The coupling agent is not particularly limited, and for example, various silane coupling agents and titanate coupling agents can be used. These may be used singly or two or more kinds thereof may be used concurrently. The amount of the coupling agent used is not particularly limited, and may be, for example, 0.1 parts by mass to 5 parts by mass or 0.5 parts by mass to 3 parts by mass with respect to 100 parts by mass of the filler used. When the amount of the coupling agent used is in this range, the deterioration of various properties is small and the advantages due to the use of the filler are likely to be effectively exerted.

In a case where a coupling agent is used, a so-called integral blending method may be used in which the coupling agent is added after the filler is blended into the resin composition, but a method is preferred in which a filler that has undergone surface treatment with a coupling agent by a dry or wet method in advance is used. By using this method, the advantages of the filler can be more effectively exerted.

The content of the component (C) in the resin composition may be 10 parts by mass to 50 parts by mass, 15 parts by mass to 45 parts by mass, 20 parts by mass to 40 parts by mass, or 25 parts by mass to 35 parts by mass with respect to 100 parts by mass of the total amount of the components (A), (B), and (C).

### (Curing Accelerator)

The resin composition of the present embodiment may further contain a curing accelerator as the component (D). Examples of the component (D) include various imidazole compounds, which are latent heat curing agents, BF₃ amine complexes, and phosphorus-based curing accelerators. In a case where a curing accelerator is blended, imidazole compounds and phosphorus-based curing accelerators are preferred from the viewpoints of the storage stability of the resin composition, the handling properties of the semi-cured resin composition, and the solder heat resistance of the cured product.

### (Flame Retardant)

The resin composition of the present embodiment may further contain a flame retardant. The flame retardant is not particularly limited, but a bromine-based flame retardant, a phosphorus-based flame retardant, a metal hydroxide and the like are suitably used.

Examples of the bromine-based flame retardant include a brominated epoxy resin, a brominated additive flame retardant, and a brominated reactive flame retardant containing an unsaturated double bond group. Examples of the phosphorus-based flame retardant include an aromatic phosphate ester, a phosphonate ester, a phosphinate ester, and a phosphazene compound. Examples of the metal hydroxide flame retardant include magnesium hydroxide and aluminum hydroxide.

The resin composition may be diluted with a solvent, if necessary. The solvent is not particularly limited, but can be determined taking into consideration the volatility during film formation from the viewpoint of the boiling point. Examples of the solvent include solvents having a relatively low boiling point, such as methanol, ethanol, 2-methoxyethanol, 2-ethoxyethanol, 2-butoxyethanol, methyl ethyl ketone, acetone, methyl isobutyl ketone, toluene, and xylene. The solvent may be used singly or in combination of two or more kinds thereof.

The resin composition of the present embodiment can be obtained by uniformly dispersing and mixing the respective components mentioned above, and the means, conditions and the like for the preparation thereof are not particularly limited. For example, a method is mentioned in which the various components are thoroughly and uniformly stirred and mixed in the predetermined blending amounts using a mixer or the like and then kneaded using a mixing roll, an extruder, a kneader, a roll, an extruder, or the like, and further the kneaded product thus obtained is cooled and pulverized. The kneading method is not particularly limited.

### [Resin Film]

A resin film can be produced using the resin composition according to the present embodiment. The resin film refers to an uncured or semi-cured resin composition in the form of a film.

The method for producing the resin film is not limited, but for example, the resin film can be obtained by applying a resin composition onto a supporting base material and drying the formed resin layer. Specifically, the resin composition may be applied onto a supporting base material using a kiss coater, a roll coater, a comma coater, or the like, and then dried in a heating and drying oven, for example, at a temperature of 70° C. to 250° C., preferably 70° C. to 200° C. for 1 minute to 30 minutes, preferably 3 minutes to 15 minutes. A resin film in which the resin composition is in a semi-cured state can be thus obtained.

The resin film in a semi-cured state can be thermally cured by further heating the resin film in a heating oven, for example, at a temperature of 170° C. to 250° C., preferably 185° C. to 230° C. for 60 minutes to 150 minutes.

The thickness of the resin film according to the present embodiment is not particularly limited, but is preferably 1 μm to 200 μm, more preferably 2 μm to 180 μm, and still more preferably 3 μm to 150 μm. By setting the thickness of the resin film in the above range, it is easy to achieve both thinning and favorable high frequency characteristics of a printed wiring board obtained using the resin film according to the present embodiment.

The supporting base material is not particularly limited, but is preferably at least one selected from the group consisting of glass, a metal foil, and a PET film. As the resin film includes a supporting base material, the storage properties and the handling properties when the resin film is used in the production of printed wiring boards tend to be favorable. In other words, the resin film according to the present embodiment can take the form of a support with a resin layer, including a resin layer containing the resin composition according to the present embodiment and a supporting base material, and may be peeled off from the supporting base material at the time of use.

### [Prepreg]

A prepreg can be produced using the resin composition according to the present embodiment. A prepreg can be obtained by applying the resin composition according to the present embodiment to a fiber base material, which is a reinforcing base material, and drying the applied resin composition. The prepreg may be obtained by impregnating a fiber base material with the resin composition according to the present embodiment, and then drying the impregnated resin composition. Specifically, a prepreg in which a resin composition is semi-cured is obtained by heating and drying a fiber base material to which the resin composition is attached in a drying oven usually at a temperature of 80° C. to 200° C. for 1 minute to 30 minutes. From the viewpoint of favorable moldability, it is preferable to coat or impregnate the fiber base material with the resin composition in such an amount that the resin content in the prepreg after drying is 30% to 90% by mass.

The reinforcing base material for the prepreg is not limited, but a sheet-like fiber base material is preferred. Examples of the sheet-like fiber base material include inorganic fibers such as E glass, NE glass, S glass, and Q glass; and organic fibers such as polyimide, polyester, and tetrafluoroethylene. As the sheet-like fiber base material, those having the shape of a woven fabric, a nonwoven fabric, a chopped strand mat, or the like can be used.

### [Laminate]

According to the present embodiment, it is possible to provide a laminate including a resin layer containing a cured product of the above-described resin composition and a conductor layer. For example, the resin film or the prepreg can be used to produce a metal-clad laminate.

The method for producing the metal-clad laminate is not limited, but a metal-clad laminate having a metal foil on at least one surface of a resin layer or prepreg that serves as an insulating layer is obtained by, for example, stacking one or more sheets of the resin film or prepreg according to the present embodiment, disposing a metal foil serving as a conductor layer on at least one surface of the stacked body, and performing heating and pressurization, for example, at a temperature of 170° C. to 250° C., preferably 185° C. to 230° C. and a pressure of 0.5 to 5.0 MPa for 60 minutes to 150 minutes. The heating and pressurization can be performed, for example, under conditions of a vacuum degree of 10 kPa or less, preferably 5 kPa or less, and is preferably performed in a vacuum from the viewpoint of increasing the efficiency. The heating and pressurization are preferably performed for 30 minutes from the start to the time from the start until the completion of molding.

### [Multilayer Printed Wiring Board]

According to the present embodiment, it is possible to provide a multilayer printed wiring board including a resin layer containing a cured product of the above-described resin composition and a circuit layer. The upper limit of the number of circuit layers is not particularly limited, and may be 3 to 20 layers. A multilayer printed wiring board can also be produced using, for example, the resin film, prepreg or metal-clad laminate.

The method for producing the multilayer printed wiring board is not particularly limited, but a multilayer printed wiring board can be produced by, for example, first disposing a resin film on one or both surfaces of a core substrate on which a circuit has been formed, or disposing a resin film between a plurality of core substrates, bonding the respective layers by pressure and heat lamination molding or pressure and heat press molding, and then performing circuit formation processing by laser drilling, drilling, metal plating, metal etching or the like. In a case where the resin film has a supporting base material, the supporting base material can be peeled off before the resin film is disposed on the core substrate or between the core substrates, or can be peeled off after the resin layer is pasted to the core substrate.

The suitable embodiments of the present disclosure have been described above, but these are merely examples for explaining the present disclosure, and it is not intended that the scope of the present invention be limited only to these embodiments. The present invention can be implemented in various forms different from the above-described embodiments without departing from the gist of the present invention.

### EXAMPLES

Hereinafter, the present disclosure will be described in more detail with reference to Examples and Comparative Examples.

However, the present invention is not limited to the following Examples.

### Synthesis Example 1

A 1 L flask was charged with 150 g of maleic anhydride-modified hydrogenated styrene-based thermoplastic elastomer (product name “TUFTEC M1913” manufactured by Asahi Kasei Corp.) and 678.6 g of toluene, and the temperature was raised to 80° C. in about 0.5 hours while stirring was performed, and then maintained at 80° C. for 1 hour to dissolve the M1913. Subsequently, the temperature was lowered to 40° C., and a solution prepared by dissolving 2.0 g of ethanolamine (manufactured by FUJIFILM Wako Pure Chemical Corporation) in 38 g of propylene glycol monomethyl ether (PGME) was added dropwise. Thereafter, the temperature was raised to 60° C. in about 0.5 hours while stirring was performed, and then maintained at 60° C. for 1 hour. Furthermore, the temperature was raised to 110° C. in about 1 hour and then maintained at 110° C. for 2 hours while nitrogen was circulated to obtain a toluene solution of a succinimide-modified styrene-based elastomer having an ethanolic hydroxyl group (A-1).

The FT-IR spectrum of (A-1) was measured using an FT-IR spectrometer (product name “IRSpirit” manufactured by SHIMADZU CORPORATION, and it was found that the peak attributed to an acid anhydride group at about 1780 cm⁻¹ disappeared and a peak attributed to an imide group was observed at about 1700 cm⁻¹.

### Synthesis Example 2

A 1 L flask was charged with 150 g of “TUFTEC M1913” and 655.7 g of toluene, and the temperature was raised to 80° C. in about 0.5 hours while stirring was performed, and then maintained at 80° C. for 1 hour to dissolve the M1913. Subsequently, the temperature was lowered to 40° C., and a solution prepared by dissolving 4.5 g of tyramine (manufactured by FUJIFILM Wako Pure Chemical Corporation) in 85.5 g of PGME was added dropwise. Thereafter, the temperature was raised to 60° C. in about 0.5 hours while stirring was performed, and then maintained at 60° C. for 1 hour. Furthermore, the temperature was raised to 110° C. in about 1 hour and then maintained at 110° C. for 2 hours while nitrogen was circulated to obtain a toluene solution of a succinimide-modified styrene-based elastomer having a phenolic hydroxyl group (A-2)

The FT-IR spectrum of (A-2) was measured, and it was found that the peak attributed to an acid anhydride group at about 1780 cm⁻¹ disappeared and a peak attributed to an imide group was observed at about 1700 cm⁻¹.

### Synthesis Example 3

A 1 L flask equipped with a condenser, a nitrogen introducing tube, a thermocouple, and a stirrer was charged with 722 g of toluene and 150 g of “TUFTEC M1913”, and the temperature was raised to 80° C. while stirring was performed, and then maintained at 80° C. for 1 hour to dissolve the M1913. Subsequently, the internal temperature of the flask was lowered to 30° C., and a solution prepared by dissolving 6.6 g of polyoxypropylenediamine (product name “Jeffermine D230” manufactured by Huntsman Corporation) in 6.6 g of toluene was added dropwise, and stirring was performed for 1.0 hour. Thereafter, 2.8 g of maleic anhydride (manufactured by FUJIFILM Wako Pure Chemical Corporation) was added, and further the temperature was maintained for 1.0 hour. After 0.53 g of p-toluenesulfonic acid was added, the internal temperature of the flask was raised to the reflux temperature (about 110° C.), and the dehydration and cyclization reaction was conducted for 3.0 hours while nitrogen was circulated to obtain a toluene solution of a succinimide-modified styrene-based elastomer having a maleimide group (A-3).

The FT-IR spectrum of (A-3) was measured, and it was found that the peak attributed to an acid anhydride group at about 1780 cm⁻¹ disappeared and a peak attributed to an imide group was observed at about 1700 cm⁻¹. The 13C-NMR spectrum (manufactured by Bruker Corporation) of (A-3) was measured, and it was found that 2 to 3 peaks attributed to the carbonyl carbon of a succinimide group and the carbonyl carbon of a maleimide group appeared in the region of 170 to 180 ppm.

### [Preparation of Resin Composition]

In order to prepare the resin compositions of Examples and Comparative Examples, the following materials were prepared.

### Component (A)

SEBS-g-HSI: Succinimide-modified styrene-based elastomer having ethanolic hydroxyl group (A-1)
SEBS-g-PhSI: Succinimide-modified styrene-based thermoplastic elastomer having phenolic hydroxyl group (A-2)
SEBS-g-MISI: Succinimide-modified styrene-based elastomer having maleimide group (A-3)

### Component (A′)

SEBS-g-MA: Maleic anhydride-modified hydrogenated styrene-based thermoplastic elastomer (product name “TUFTEC M1913” manufactured by Asahi Kasei Corp.)
SEBS: Hydrogenated styrene-based thermoplastic elastomer (product name “TUFTEC H1041” manufactured by Asahi Kasei Corp.)

### Component (B)

Epoxy resin: Dicyclopentadiene type epoxy resin (product name “EPICLON HP7200H” manufactured by DIC Corporation)
Phenol resin: Cresol novolac type phenol resin: (product name “KA1165” manufactured by DIC Corporation)
Maleimide resin: Biphenylaralkyl type maleimide resin (product name “MIR-3000” manufactured by Nippon Kayaku Co., Ltd.)

### Component (C)

Filler: Surface-treated silica particles (product name “SC-2050KNK” manufactured by ADMATECHS COMPANY LIMITED)

### Component (D)

Curing accelerator: 1-Ethyl-4-methylimidazole (product name “CUREZOL 2E4MZ” manufactured by SHIKOKU CHEMICALS CORPORATION)

### Example 1

A 1 L separable flask equipped with a thermometer, a reflux condenser, and a stirrer was charged with toluene and methyl isobutyl ketone (MIBK), which were solvents, and 30 parts by mass of SEBS-g-HSI as the component (A), and stirring was performed at 80° C. Subsequently, an epoxy resin and a phenol resin as the component (B), a silica filler as the component (C), and 2E4MZ as the component (D) were added in the blending amounts (parts by mass) presented in Table 1, mixing was performed, and then MIBK was further added to prepare a resin composition having a solid concentration of about 33% by mass.

### Example 2

A resin composition was prepared in the same manner as in Example 1, except that the component (A) was changed to SEBS-g-PhSI.

### Example 3

A resin composition was prepared in the same manner as in Example 1, except that the component (A) was changed to SEBS-g-MISI and the component (B) was changed to a maleimide resin.

### Example 4

A resin composition was prepared in the same manner as in Example 1, except that the component (A) was changed to SEBS-g-MISI (27 parts by mass) and SEBS-g-MA (3 parts by mass).

### Example 5

A resin composition was prepared in the same manner as in Example 1, except that the component (A) was changed to SEBS-g-MISI (27 parts by mass) and H1041 (3 parts by mass).

### Comparative Example 1

A resin composition was prepared in the same manner as in Example 1, except that the component (A) was changed to SEBS-g-MA.

### Comparative Example 2

A resin composition was prepared in the same manner as in Example 1, except that the component (A) was changed to H1041. [Evaluation of resin composition]

### (Viscosity)

The viscosity (η1) of the resin composition immediately after preparation was measured at 25° C. and a frequency of 10 radians/sec using parallel plates and a viscosity measuring instrument (product name: DSR-200 manufactured by Rheometric Scientific, Inc.). Subsequently, the resin composition was left in an incubator at 25° C. for one week, and then the viscosity (η2) was measured. The resin composition of Comparative Example 2 exhibited poor compatibility and was not uniform, and it was not possible to measure the viscosity thereof.

### (Stability)

The viscosity increase ratio was determined by η1/η2 to evaluate the stability of the resin composition at room temperature.

TABLE 1

| | | | | | | | Comparative | |
|---|---|---|---|---|---|---|---|---|
| | | Example | | | | | Example | |
| | | 1 | 2 | 3 | 4 | 5 | 1 | 2 |
| (A) | SEBS-g-HSI | 30 | — | — | — | — | — | — |
| | SEBS-g-PhSI | — | 30 | — | — | — | — | — |
| | SEBS-g-MISI | — | — | 30 | 27 | 27 | — | — |
| (A′) | SEBS-g-MA | — | — | — | 3 | — | 30 | — |
| | H1041 | — | — | — | — | 3 | — | 30 |
| (B) | Epoxy resin | 30 | 30 | — | 30 | 30 | 30 | 30 |
| | Phenol resin | 10 | 10 | — | 10 | 10 | 10 | 10 |
| | Maleimide | — | — | 40 | — | — | — | — |
| | resin | | | | | | | |
| (C) | Filler | 30 | 30 | 30 | 30 | 30 | 30 | 30 |
| (D) | Curing | 0.25 | 0.25 | 0.25 | 0.25 | 0.25 | 0.25 | 0.25 |
| | accelerator | | | | | | | |
| Solvent | Toluene | 160 | 160 | 160 | 160 | 160 | 160 | 160 |
| | MIBK | 40 | 40 | 40 | 40 | 40 | 40 | 40 |
| Viscosity | η1 | 1210 | 1290 | 1380 | 1330 | 1320 | 1220 | — |
| | η2 | 1490 | 1550 | 1520 | 1680 | 1670 | Gelled | — |
| Stability | η1/η2 | 1.2 | 1.2 | 1.1 | 1.3 | 1.3 | — | — |

1. A resin composition comprising a modified styrene-based elastomer having an N-substituted succinimide group in a side chain; and a thermosetting resin.

2. The resin composition according to claim 1, wherein the N-substituted succinimide group has a structure represented by the following Formula (1): 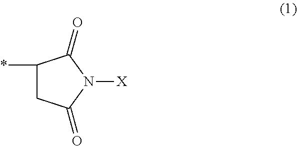
wherein in Formula (1), X represents a monovalent organic group, and * represents a bonding portion.

3. The resin composition according to claim 2, wherein the X is a monovalent organic group having at least one selected from the group consisting of an isocyanate group, a hydroxyl group, a carboxyl group, a silanol group, a thiol group, a sulfo group, a phosphoric acid group, a cyclic ether group, a carbonate group, a nitrile group, a (meth)acryloyl group, a vinyl group, a maleimide group, an imidazole group, an oxazoline group, a benzotriazole group, and a benzoxazine group.

4. The resin composition according to claim 2, wherein the N-substituted succinimide group has a structure represented by the following Formula (2) or the following Formula (3): 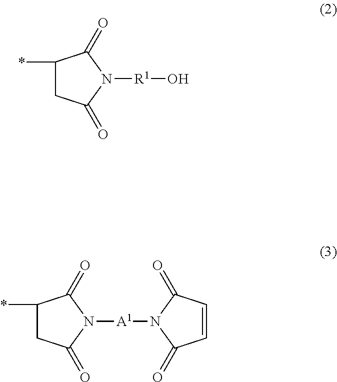
wherein in Formula (2), R¹ represents a residue of an amine compound having a hydroxyl group, and * represents a bonding portion, and in Formula (3), A¹ represents a residue of a diamine compound, and * represents a bonding portion.

5. The resin composition according to claim 1, wherein the thermosetting resin includes at least one selected from the group consisting of an epoxy resin, a cyanate ester resin, an acrylic resin, a silicone resin, a phenol resin, a maleimide resin, a thermosetting polyimide resin, a polyurethane resin, a melamine resin, and a urea resin.

6. The resin composition according to claim 1, wherein a content of the modified styrene-based elastomer is 1% to 50% by mass based on a total amount of solids in the resin composition.
